(19) United States
(12) Patent Application Publication
(10) Pub. No.: US 2022/0012571 A1
(43) Pub. Date: Jan. 13, 2022

(54) APPARATUS, METHOD, AND COMPUTER-READABLE MEDIUM FOR ACTIVATION FUNCTION PREDICTION IN DEEP NEURAL NETWORKS

(71) Applicants: Kamlesh Pillai, Bangalore (IN); Gurpreet Singh Kalsi, Bangalore (IN); Bharathwaj Suresh, Bangalore (IN); Sreenivas Subramoney, Bangalore (IN); Avishaii Abuhatzera, Qiriat Shemona (IL)

(72) Inventors: Kamlesh Pillai, Bangalore (IN); Gurpreet Singh Kalsi, Bangalore (IN); Bharathwaj Suresh, Bangalore (IN); Sreenivas Subramoney, Bangalore (IN); Avishaii Abuhatzera, Qiriat Shemona (IL)

(21) Appl. No.: 17/484,423

(22) Filed: Sep. 24, 2021

(51) Int. Cl. G06N 3/04; G06N 3/10

(52) U.S. Cl. CPC G06N 3/0481; G06N 3/10

(57) ABSTRACT

Apparatuses and articles of manufacture are disclosed. An example apparatus includes an activation function control and decode circuitry to populate an input buffer circuitry with an input data element bit subset of less than a threshold number of bits of the input data element retrieved from the memory circuitry. The activation function and control circuitry also populate a kernel weight buffer circuitry with a weight data element bit subset of less than the threshold number of bits of the weight data element retrieved from the memory circuitry. The apparatus also including a preprocessor circuitry to calculate a partial convolution value of at least a portion of the input data element bit subset and the weight data element bit subset to determine a predicted sign of the partial convolution value.

### FIELD OF THE INVENTION

The invention relates to artificial neural networks. More specifically, the invention relates to predicting the sign of an activation function in an artificial neural network.

### BACKGROUND

Artificial neural networks, such as convolutional neural networks (CNNs), are utilized for many tasks. Among those tasks are learning to accurately make predictions. For example, a CNN can receive a large amount of image data and learn, through machine learning (ML) to classify content in images.

### BRIEF DESCRIPTION OF THE DRAWINGS

FIG. 1 is a schematic illustration of an example system architecture that predicts the sign of an activation function result.

FIG. 2 illustrates an example arrangement of rearranged single-precision floating-point format (FP32) input and weight data in L1 memory.

FIG. 3 is a flowchart representative of example machine readable instructions that may be executed by example processor circuitry to implement a prediction of the sign for a (rectified linear unit) ReLU activation function with partial data.

FIG. 4 is another flowchart representative of example machine readable instructions that may be executed by example processor circuitry to implement a prediction of the sign for the ReLU activation function with partial data.

FIG. 5 illustrates an example of the layout of a memory storing the data described in the discussion related to the flowchart of FIG. 4.

FIG. 6A illustrates an example number format of an FP32 data type used for predicting a ReLU activation function result in a CNN.

FIG. 6B illustrates an example region of interest where a reduced precision of an FP32 input value and weight value used to calculate a partial convolution value may cause a prediction error of a ReLU activation function result.

FIG. 7 is a block diagram of an example processor platform 700 structured to execute and/or instantiate the machine readable instructions and/or operations of FIGS. 3 through 5 to implement the apparatus of FIG. 1.

FIG. 8 is a block diagram of an example implementation of the processor circuitry 712 of FIG. 7.

FIG. 9 is a block diagram of another example implementation of the processor circuitry 712 of FIG. 7.

FIG. 10A illustrates an example distribution graph of ReLU zero results across all layers (i.e., nodes) of the ResNet-50 model when run through an ImageNet dataset.

FIG. 10B-10D illustrate samples of the accuracy of the predicted negative result on a sample of three different convolution layers in the ResNet-50 model across a scale of mantissa bits used in the prediction.

FIG. 11A illustrates an example distribution graph of ReLU zero results across all layers (i.e., nodes) of the VGG-16 model when run through the ImageNet dataset.

FIG. 11B-11D illustrate samples of the accuracy of the predicted negative result on a sample of three different convolution layers in the VGG-16 model across a scale of mantissa bits used in the prediction.

The figures are not to scale. Instead, the thickness of the layers or regions may be enlarged in the drawings. In general, the same reference numbers will be used throughout the drawing(s) and accompanying written description to refer to the same or like parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Artificial neural networks, such as convolutional neural networks (CNNs), are utilized for many tasks. Among those tasks is learning to accurately make predictions. For example, a CNN can receive a large amount of image data and learn, through machine learning (ML), to classify content in images. In a CNN, the processes of image recognition and image classification commonly utilize a rectified linear unit (ReLU) as an activation function in practice. For a given node (also referred to as a layer) in a CNN, when fitting input data for recognition or classification, the ReLU activation function calculates the convolution of the input data with weight and bias parameter values. Whether these values are floating point, fixed point, or integer based, there is an overhead associated with such calculations. In a complex neural network that has a large number of nodes, the overhead will increase. Some of this overhead is wasted because any ReLU calculation result that returns a negative value is thrown out and never contributes to the CNN's output.

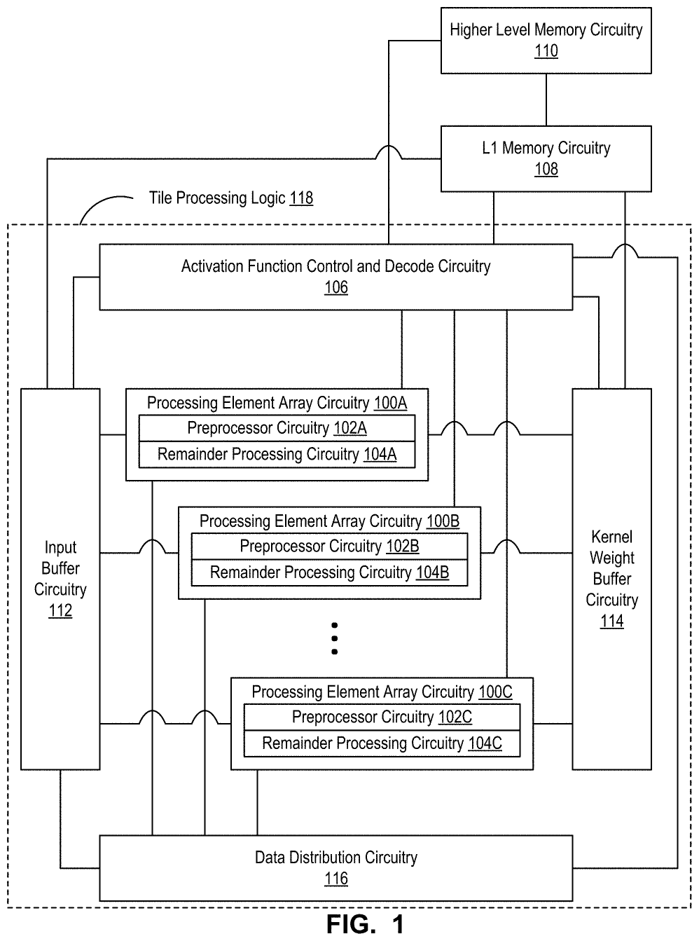

FIG. 1 is a schematic illustration of an example system architecture that predicts the sign of an activation function result.

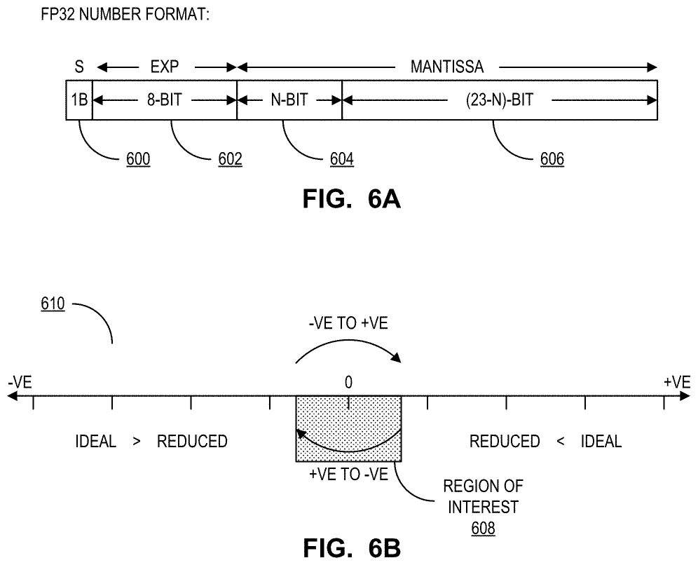

In some examples, input data, weight data, and bias data utilized in a CNN are in a 32-bit floating point (FP32) data type format. The FP32 data type format includes a sign bit (bit [31]), a set of exponent bits (bits [30:23]), and a set of mantissa bits (bits [22:0]). In other examples, one or more other data types may be utilized, such as fixed point or 8-bit integer data types, among others. The examples described below will largely be utilizing FP32, but any one or more other data types might be utilized in practice (e.g., double precision floating point (FP64), 8-bit integer, 16-bit integer, 32-bit integer, 64-bit integer, etc.). See FIG. 6A and the corresponding discussion involving FIG. 6A below for a more detailed review of an example of the FP32 number format.

Typical CNNs utilize an activation function per node to map the input data to a series of weights and biases for image training and/or classification purposes. One of the most common activation functions in practice is the ReLU activation function. The examples described below will largely be utilizing the ReLU function for ease of explanation. In other examples, other activation functions that have similar behaviors to the ReLU function may be implemented in addition to or in place of the ReLU function (e.g., the leaky ReLU function) in some or all of the CNN nodes that use an activation function.

In some examples, the ReLU function consumes the output of a convolution layer in a CNN. The ReLU function clamps all the negative output values to zero (i.e., all the operations performed during the convolution layer resulting negative values are neutralized/discarded). Although the ReLU function is efficient from storage perspective because calculated convolution values with negative results are thrown out, there are still inefficiencies. For example, since the ReLU function throws out negative value results, there ends up being significant volumes of convolution calculations that are not further used.

If the result of each convolution calculation were able to be accurately predicted, the processing circuitry calculating the convolutions could be instructed to ignore calculations that end up as negative values. Thus, one purpose of predicting a sign (i.e., positive or negative) of a convolution result is to allow the hardware accelerator(s) performing the calculations to discontinue further calculations on input values that will have a negative ReLU result.

The hardware accelerator(s) process image data (and/or other data) layer by layer through the CNN in a tiled fashion. A tile is herein defined as a group of elements, each of which is a portion of the tile. For example, data from an image may be segmented into a series of 4×4 blocks of pixels, which also may be referred to as a 4×4 tile of (pixel) data elements. In some examples, each element is a base input data building block with which larger structures may be grouped, such as tiles. In some examples, hardware accelerators process data through a CNN in a tiled manner because each element in the tile is not dependent upon any calculated results of the other elements.

In the illustrated example in FIG. 1, a series of processing element array circuitries (100A, 100B, 100C) are present. In some examples, more processing element array circuitries are present. Although three processing element array circuitries are shown for the sake of simplicity in the discussion, many hardware accelerators are massively parallel and may have hundreds or more processing element array circuitries. The example processing element array circuitries 100A-100C are generally arranged in one or more systolic arrays of multiply-accumulate (MAC) blocks to increase performance and area efficiency. In some examples, there may be other blocks in addition to MAC blocks utilized to perform other types of calculations needed for nodes in the processing element array circuitries 100A-100C.

In some examples, circuitry comprising tile processing logic encapsulated in box 118 of FIG. 1 calculates input and weight values across each of the elements of a tile for each convolution node. The output of each convolution node includes a series of calculations utilizing input data and weight data processed by tile processing logic 118. The input data is defined herein as the data input into the CNN. For example, an image might be input into the CNN for the purpose of training the CNN or for the purpose of classifying the image once the CNN has been trained. The weight data is defined herein as a weighted value created through training the CNN (e.g., through backpropagation) and utilized as part of a connection between two given nodes. The weight data, when applied through a series of calculations to an input data from the previous node (or from the starting node), fits the input data to the model in the CNN.

In the illustrated example in FIG. 1, logic blocks/circuitries at least within tile processing logic 118 are utilized to perform at least an activation function computation in one or more CNN nodes. In some examples, the activation function is a ReLU function (or a similar function to ReLU). Thus, the logic block/circuitries in FIG. 1 will throw away negative results.

In some examples, for tile based FP32 operations at the nodes of a CNN, the output of each convolution node can be predicted by performing a partial FP32 calculation instead of performing a full FP32 calculation. More specifically, for a given example node that performs a ReLU function (or another activation function similar to ReLU), a partial FP32 calculation on the input data and the weight data in certain circumstances can lead to an accurate prediction of the sign (i.e., positive or negative) of the result. For a function like ReLU, predicting the sign of the result can lead to a more efficient flow of calculations of the tile of input data because all predicted negative results allow for discontinuing any remaining FP32 calculations.

For FP32 data type calculations, each example input data value and weight data value can be divided into two distinct groups/segments of bits (e.g., two subsets of the 32-bit total). In some examples, a first group includes sign bit (600 in FIG. 6A), the exponent bits (602 in FIG. 6A), and a set of upper mantissa bits (604 in FIG. 6A). And a second group includes a set of lower mantissa bits (606 in FIG. 6A). In some examples, calculations involving the first group of FP32 bits will be handled by the preprocessor circuitry 102A-102C and calculations involving the second group of FP32 bits will be handled by remainder processing circuitry 104A-104C.

In some examples, the size of a tile of the input data may be utilized to help determine an efficient division of mantissa bits that make up the upper mantissa bits vs. the mantissa bits that make up to the lower mantissa bits. An example mathematical proof to determine an efficient division of mantissa bits is described below following the description of FIG. 6B. In one example, the upper mantissa consists of 4 bits and the lower mantissa consists of 19 bits (i.e., the dividing line between the upper mantissa and the lower mantissa is between bits 18 and 19 in an FP32 number format). In other examples, the dividing line may be between higher or lower bits than bits 18 and 19.

While the examples described largely utilize a mantissa separated into two sections (an upper mantissa and a lower mantissa), it should be appreciated that in other examples the mantissa could be split into additional sections, such as in three sections (a lower mantissa, a middle mantissa section, and an upper mantissa section) or more.

In the illustrated example in FIG. 1, the processing element array circuitries 100A-100C include preprocessor circuitry (102A, 102B, and 102C, respectively) and remainder processing circuitry (104A, 104B, and 104C, respectively). In some examples, for each processing element array circuitry 100A-100C, the systolic array(s) of MAC blocks in the circuitry are separated into two groups, a group of MAC blocks defined as the preprocessor circuitry 102A-102C and a group of MAC blocks defined as the remainder processing circuitries 104A-104C. In some examples, the number of MAC blocks assigned to each preprocessor circuitry 102A-102C and the number of MAC blocks assigned to each remainder processing circuitry 104A-104C can be adjusted depending on the need of the input data workload.

In some examples, the preprocessor circuitry 102A-102C calculates a partial convolution of the data using the first subset of FP32 bits for each of the input data elements and weight data elements at a given node. More specifically, in some examples, the following preprocessing operations are performed on the first subset of FP32 bits of the input data and the weight data by preprocessor circuitry 102A-102C:

1) XOR of sign bit

2) Perform multiplication on exponent bits (i.e., addition of exponents)

3) Perform multiplication on upper mantissa bits

Performing this set of operations on the first group of bits is herein referred to as calculating a partial convolution value (using the input data and weight data to do so). The value is a partial convolution because only a subset of FP32 bits that make up an input value and a weight value are used. Thus, in some examples, using the sign bit, the 8-bit exponent, and a 4-bit upper mantissa (bits [31:19]) from each of the input data and weight data values, the preprocessor circuitry 102A-102C calculates the partial convolution value. The result of the calculation will produce a value that can be positive or negative (or zero), herein referred to as the predicted sign. In some examples, the preprocessor circuitry 102A-102C can then send the predicted sign to control and decode circuitry 106.

In some example versions of a ReLU activation function or another similar function, the convolution data results are utilized for subsequent nodes in the CNN only if the result for a given node is positive. In other example versions of a ReLU or similar activation function, a zero result may default to a utilized result, thus in those versions the CNN nodes send the convolution results to subsequent nodes as long as the results are non-negative. Either version can be utilized for this process, but for simplicity the examples will focus around a non-negative convolution result being utilized.

In some examples, the predicted sign (also herein referred to as a sign indicator) may be a flag register, a designated bit in a hardware or software register, a communication packet, or any other type of signal meant to communicate a piece of information (e.g., information designating that the calculated partial convolution value is positive or negative). The sign information is referred to as “predicted” instead of known because the reduced number of mantissa bits utilized in the calculation introduces a certain amount of variability/error vs. the true/ideal value calculation utilizing all FP32 bits.

In some examples, the control and decode circuitry 106 (also referred to herein as the control 106) has logic that controls the flow of much of the system illustrated in FIG. 1. In some examples, the control 106 and the processing element array circuitries 100A-100C are each one or more hardware blocks of circuits in a graphics processing unit (GPU). In other examples, the control 106 and the processing element array circuitries 100A-100C are one or more blocks of circuits in an accelerator chip designed for artificial neural networks and/or other artificial intelligence applications. In yet other examples, the control 106 and the processing element array circuitries 100A-100C are one or more blocks of circuits in other hardware such as circuits in a central processing unit (CPU), in a memory controller, in an I/O controller, in a fixed programmable gate array (FPGA) chip, or in any other possible hardware circuitry where these circuits could be applicable. In yet other examples, the control 106 and the processing element array circuitries 100A-100C are implemented virtually in a software environment and the software environment is then run on one or more computer systems, such as mobile devices, laptops, desktops, workstations, and/or servers.

In the illustrated example in FIG. 1, the control 106 includes logic that loads/populates data into and fetches data from one or more memory circuitries, such as the L1 memory circuitry 108 and the higher level memory circuitry 110. In some examples, the L1 memory circuitry 108 is on the same die as the control 106 and processing element array circuitries 100A-100C. In other examples, the L1 memory circuitry 108 is on an adjacent die in the same semiconductor package as the control 106 and processing element array circuitries 100A-100C. In some examples, the higher level memory circuitry 110 is on an adjacent die in the same semiconductor package as the control 106 and processing element array circuitries 100A-100C. In other examples, the higher level memory circuitry 110 is in a discrete package/location from the control 106 and processing element array circuitries 100A-100C (e.g., such as part of discrete SDRAM memory substrates plugged into a motherboard's memory slot(s)).

In some examples, the control 106 includes logic to fetch at least input data and weight data from the higher level memory circuitry 110. As described above, in some examples, the input data and weight data that is fetched is in the FP32 format. Once the input data and weight data have been fetched, they can be stored into the L1 memory circuitry 108. In some examples, the control 106 performs and/or triggers a process to rearrange the FP32 data format into the portions that will be operated on independently. The control 106 then stores/loads the example rearranged data in L1 memory circuitry 108.

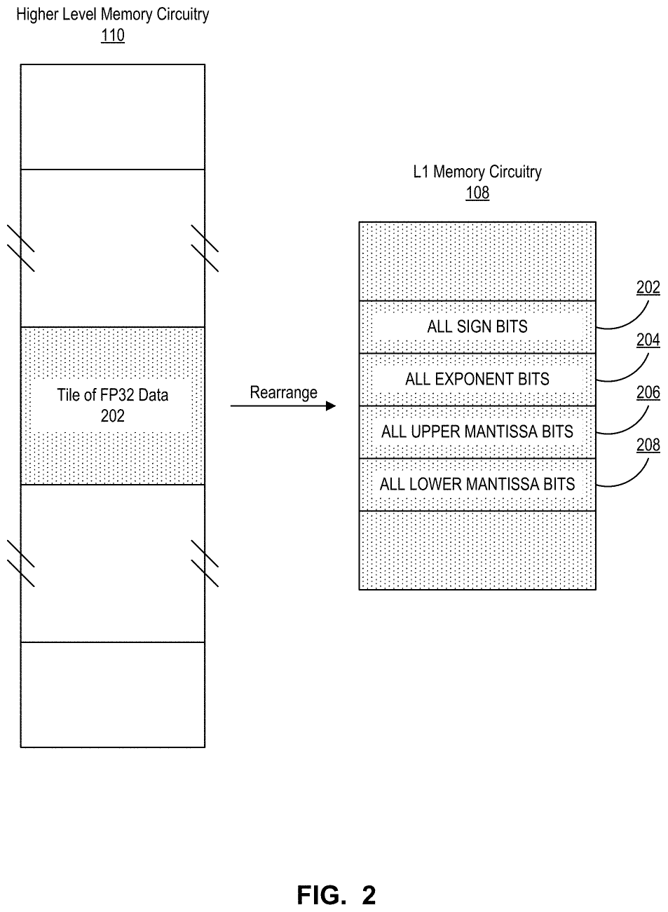

FIG. 2 illustrates an example arrangement of rearranged FP32 input and weight data in L1 memory 108. According to the illustrated example, the higher level memory 110 has at least a tile of FP32 format data (200 in FIG. 2). In some examples, the control (106 in FIG. 1) takes each 32-bit floating point value and separates it into four portions (i.e., four subsets of the total 32 bits): the 1-bit sign portion, the 8-bit exponent portion, and the 23-bit mantissa portion (which is split into an upper mantissa portion lower mantissa portion). In some examples, these four portions can be grouped across elements of a tile. For example, if a tile is made up of a 4×4 set of FP32 elements, then the control 106 stores 16 portions of each group of data into a specified memory area in the L1 memory circuitry 200.

In the illustrated example in FIG. 2, the control 106 stores 16 subsets of 1-bit signs in an all sign bits location 202 (e.g., a sign bit group of data) of L1 memory circuitry 108, 16 subsets of 8-bit exponents in an all exponent bits location 204 (e.g., an exponent bits group of data) of L1 memory circuitry 108, 16 subsets of upper mantissa bits in an all upper mantissa bits location 206 (e.g., an upper mantissa bits group of data) of L1 memory circuitry 108, and 16 subsets of lower mantissa bits in an all lower mantissa bits location 208 (e.g., a lower mantissa bits group of data) of L1 memory circuitry 108. In some examples, the 16 FP32 elements that make up each element of the 4×4 tile represent 16 pixels of an image or 16 of any defined basic block that makes up a larger set of input data fetched from higher level memory circuitry 110 (e.g., for pixels, the larger set of input data may be an entire image).

Returning to the illustrated example in FIG. 1, the system includes an input buffer circuitry (IBC) 112 and a kernel weight buffer circuitry (KWBC) 114. In some examples, the IBC 112 and the KWBC 114 are portions of a memory in the system in FIG. 1. For example, the IBC 112 and the KWBC 114 may be portions of the L1 memory circuitry 108 that have been dynamically allocated as buffers by the control 106. In other examples, the IBC 112 and KWBC 114 are specialized memory storage on or near the control 106 and the processing element array circuitry 100A-100C chip(s) designated for artificial neural network matrix math operations. In yet other examples, the IBC 112 and the KWBC 114 may be any other form of memory storage capable of storing input data and weight data that are accessible by other circuitry in the system in FIG. 1. In some embodiments, the IBC 112 includes multiple banks of storage to store several, elements, tiles and/or images simultaneously.

In some examples, the control 106 loads the IBC 112 and the KWBC 114 with input data and weight data, respectively, retrieved from the L1 memory circuitry 108. In some examples, the control 106 initially loads a subset of input data and weight data associated with the sign bit, the exponent bits, and the upper mantissa bits into the IBC 112 and the KWBC 114, respectively (e.g., the first three groupings of bits associated with the rearranged FP32 input data). In some examples, during a single data load into the IBC 112 and the KWBC 114, the amount of data loaded includes the three groupings of bits associated with all the elements of a tile of data. In other examples, during a single data load into the IBC 112 and the KWBC 114, the amount of data loaded includes the three groupings of bits associated with a single element of a tile. In yet other examples, during a single data load into the IBC 112 and the KWBC 114, the amount of data loaded includes the three groupings of bits associated with more than one tile, which may be up to and including loading all tiles of an image.

In some examples, the weight buffer information may not need to be updated once the CNN is trained. Thus, in some examples, the weight data for all four groupings of bits associated with the FP32 rearranged data is loaded once into the KWBC 114 at the beginning of the process for a tile and may be utilized across a series of partial convolution calculations involving multiple input data elements across one or more tiles (e.g., potentially for an entire image of input data calculations).

In the illustrated example of FIG. 1, once all relevant data from at least the first three groupings of bits have been loaded into the IBC 112 and the KWBC 114, the control 106 triggers the preprocessor circuitries 102A-102C to begin calculating the partial convolution value (e.g., the series of three preprocessing operations described above) for each element in the input data. For example, for a given node in the CNN, preprocessor circuitry 102A performs the three preprocessor calculations (i.e., XOR the sign bit, add the exponent bits, and multiply the upper mantissa bits) using a first element of input data and the weight data associated with the given node. In some examples, the partial convolution value may be calculated across all elements in a given tile in parallel utilizing a group of the preprocessor circuitries 102A-102C.

In some examples, the control 106 includes logic that can receive indicators of certain conditions and act on those conditions (e.g., the control 106 can trigger processes to occur in other logic blocks in FIG. 1).

In the illustrated example in FIG. 1, the control 106 receives an indicator of a predicted sign from one or more of the preprocessor circuitries 102A-102C. As described above, the predicted sign is determined from one or more of the preprocessor circuitries 102A-102C calculating a partial convolution result using a partial set of bits of the input data and weight data retrieved from the IBC 112 and the KWBC 114.

In some examples, the preprocessor circuitries 102A-102C store the partial convolution result value in a data distribution circuitry (DDC) 116. In some examples, the partial convolution result value is stored in the DDC 116 only if the predicted sign is determined to be non-negative. In some examples, the DDC 116 is a portion of a memory in the system in FIG. 1. For example, the DDC 116 may be a portion of the L1 memory circuitry 108 that has been dynamically allocated as a buffer by the control 106. In other examples, the DDC 116 is a specialized memory storage on or near the control 106 and the processing element array circuitry 100A-100C chip(s) designated for artificial neural network matrix math operations. In yet other examples, the DDC 116 may be any other form of memory storage capable of storing results data that are accessible by other circuitry in the system in FIG. 1. In some examples, the preprocessor circuitries 102A-102C additionally include logic circuitry that have the capability of store/load functionality to directly store the data in the DDC 116. In other examples, the control 106 performs the store of the partial convolution results data to the DDC 116.

Using the ReLU activation function as the example, if the predicted sign indicator (determined/calculated by the preprocessor circuitries 102A-102C and sent to the control 106) is non-negative, then the control 106 performs one or more resulting functions. In some examples, the control 106 will trigger (e.g., cause through some form of indicator/communication) one or more of the remainder processing circuitries 104A-104C to calculate the remaining portion of the convolution value using the remaining bits of the input data and weight data that were not calculated by the one or more preprocessor circuitries 102A-102C. For example, if the preprocessor circuitries 102A-102C calculated the partial convolution value from the sign bit, the 8-bit exponent, and a 4-bit upper mantissa (e.g., the most significant 13 bits total of the original FP32 operand), then the remainder processing circuitries 104A-104C calculates the convolution value of the 19-bit lower mantissa.

The example remainder processing circuitries 104A-104C combines the result of the 19-bit lower mantissa with a partial convolution result of the most significant 13 bits stored in the DDC 116 to create a full convolution value. In the illustrated example in FIG. 1, the calculated full convolution value (i.e., the combined result from the upper 13-bit calculation and the lower 19-bit calculation) is stored in the DDC 116. In some examples, the calculated full convolution value, or at least a portion of the value, is then loaded into the IBC 112 to allow the processing element array circuitries 100A-100C to calculate a next partial convolution value for a next node in the CNN (using a next weight data for the next node from the KWBC 114).

In some examples, if the predicted sign of the partial convolution value calculated by the preprocessor circuitries 102A-102C is negative, then the control 106 does not trigger a further calculation by the remainder processing circuitries 104A-104C and the partial convolution value is discarded from further use. In some examples, the negative predicted sign partial convolution value is not stored in the DDC 116. In other examples, the negative predicted sign partial convolution value is stored in the DDC 116, but upon determining the sign is negative, the control 106 flags the partial convolution value as invalid and the data can then subsequently be overwritten.

In some examples, the triggering process takes place on an entire tile of input data at the same time, across a group of remainder processing circuitries 104A-104C. In other examples, the triggering process can take place separately per element (i.e., per remainder processing circuitry). In some examples, for ReLU or similar activation functions, remainder processing circuitries 104A-104C that do not receive triggers will not calculate the lower mantissa bits of a given convolution, thus saving processing cycles.

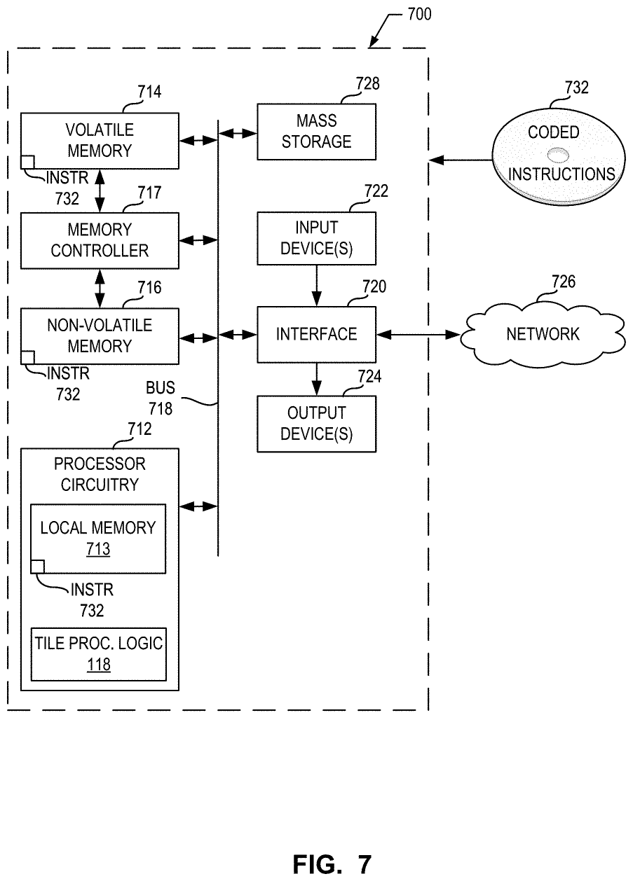

A more detailed set of possible example implementations of the circuitry logic blocks shown in FIG. 1 are described below in the discussion related to FIGS. 7-9.

While an example manner of implementing the apparatus that predicts signs for the ReLU activation function with partial data is illustrated in FIG. 1, one or more of the elements, processes, and/or devices illustrated in FIG. 1 may be combined, divided, re-arranged, omitted, eliminated, and/or implemented in any other way. Further, the processing element array circuitries 100A-100C (including the preprocessor circuitries 102A-102C and the remainder processing circuitries 104A-104C), the control 106 (i.e., the activation function control and decode circuitry), the L1 memory circuitry 108, the higher level memory circuitry 110, the IBC 112, the KWBC 114, the DDC 116, and/or, more generally, the example apparatus and system of FIG. 1, may be implemented by hardware, software, firmware, and/or any combination of hardware, software, and/or firmware. Thus, for example, any of the example processing element array circuitries 100A-100C (including the example preprocessor circuitries 102A-102C and the example remainder processing circuitries 104A-104C), the example control 106 circuitry, the example L1 memory circuitry 108, the example higher level memory circuitry 110, the example IBC 112, the example KWBC 114, the example DDC 116, and/or, more generally, the example system of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example processing element array circuitries 100A-100C (including the example preprocessor circuitries 102A-102C and the example remainder processing circuitries 104A-104C), the example control 106 circuitry, the example L1 memory circuitry 108, the example higher level memory circuitry 110, the example IBC 112, the example KWBC 114, the example DDC 116, and/or, more generally, the example apparatus and system of FIG. 1 is/are hereby expressly defined to include a non-transitory computer readable storage medium, device or storage disk such as a memory, a digital versatile disk (DVD), a compact disk (CD), a Blu-ray disk, etc., including the software and/or firmware. Further still, the example apparatus and system of FIG. 1 may include one or more elements, processes, and/or devices in addition to, or instead of, those illustrated in FIG. 1, and/or may include more than one of any or all of the illustrated elements, processes and devices.

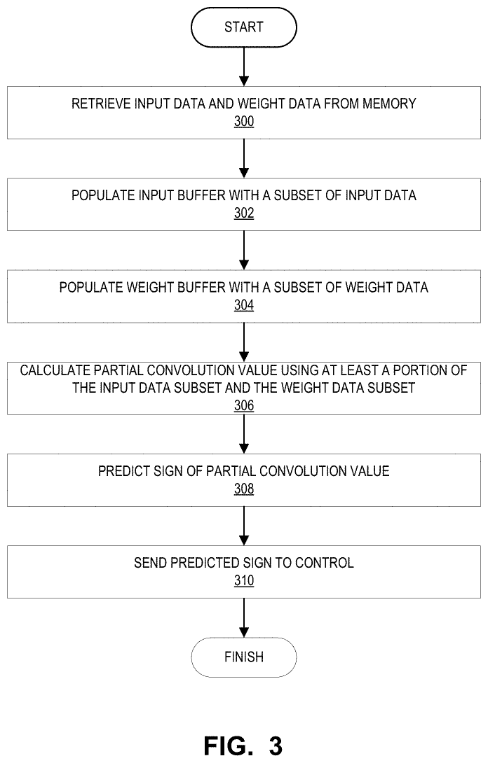

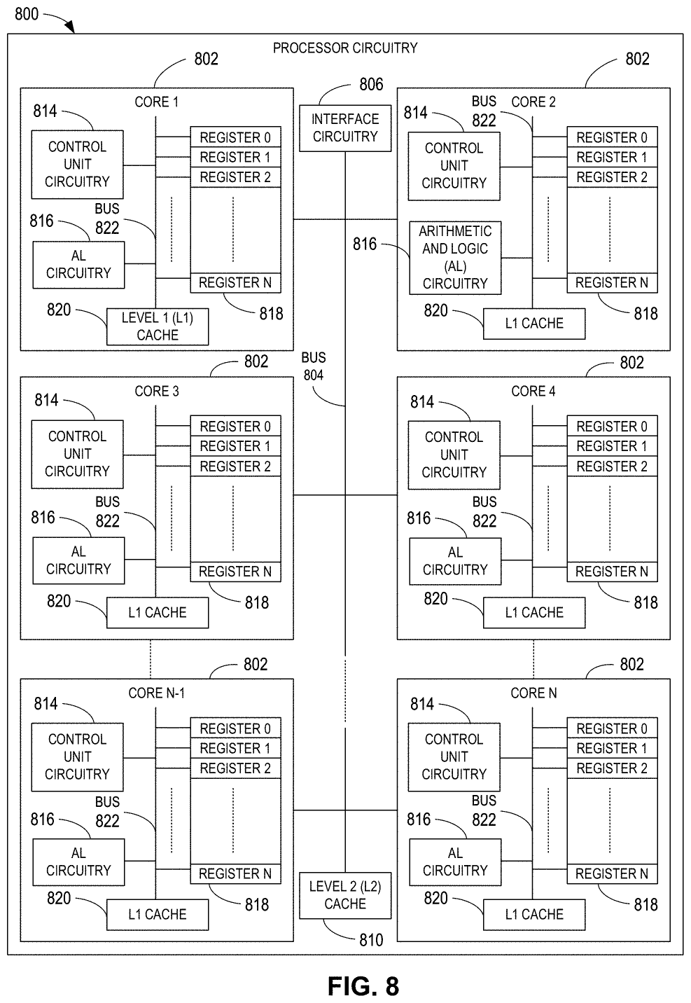

A flowchart representative of example hardware logic circuitry, machine readable instructions, hardware implemented state machines, and/or any combination thereof for implementing the apparatus and system of FIG. 1 is shown in FIG. 3. The machine readable instructions may be one or more executable programs or portion(s) of an executable program for execution by processor circuitry, such as the processor circuitry 712 shown in the example processor platform 700 discussed below in connection with FIG. 7 and/or the example processor circuitry discussed below in connection with FIGS. 8 and/or 9. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 3, many other methods of implementing the example apparatus of FIG. 1 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3 through 5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions that may be executed by example processor circuitry to implement a prediction of the sign for the ReLU activation function with partial data. The process flow is performed by the processing element array circuitries 100A-100C (including the preprocessor circuitries 102A-102C and the remainder processing circuitries 104A-104C), the control 106 (i.e., the activation function control and decode circuitry), the L1 memory circuitry 108, the higher level memory circuitry 110, the IBC 112, the KWBC 114, the DDC 116 as illustrated in FIG. 1.

In the illustrated example of FIG. 3, when input data is sent to a CNN to be processed (e.g., an image is sent through a CNN to be classified) the process begins, at block 300, where the control 106 retrieves input data and weight data from memory.

The example process continues at block 302 with the control 106 populating the IBC 112 with a subset of the input data. In some examples, the data loaded has been rearranged into groups from an initial FP32 format. Thus, in some examples, the sign bit, the exponent bits, and a group of upper mantissa bits make up the subset of input data loaded into the IBC 112.

The example process continues at block 304 with the control 106 populating the KWBC 114 with a subset of the input data. Similarly to the group of data loaded into the IBC 112 in block 302 above, in some examples, the sign bit, the exponent bits, and a group of upper mantissa bits make up the subset of weight data loaded into the KWBC 114.

The example process continues at block 306 when one or more of the preprocessor circuitries 102A-102C calculate a partial convolution value using at least a portion of the input data subset and the weight data subset. In some examples, the partial convolution calculation uses the entire subset of the sign bit, the exponent bits, and the upper mantissa bits. In other examples, an initial partial convolution calculation uses only the sign bit and the exponent bits to calculate a first partial convolution value. In some examples, it is possible to predict the sign of the partial convolution using only the values of the sign bit and the exponent bits of the input data and weight data. In these situations, the entirety of the FP32 mantissa (both upper and lower portions) is not significant enough to possibly change the predicted sign.

The example process continues at block 308 when one or more of the preprocessor circuitries 102A-102C predict the sign of the partial convolution value calculated in block 306. In some examples, if the predicted sign is negative, the sign can't turn positive no matter what subset of additional less significant bits are utilized in subsequent calculations of the convolution value, thus a negative result is known. In some examples, if the predicted sign is positive, the sign still may possibly turn negative once additional less significant bits are considered in subsequent calculations.

The example process continues at block 310 when one or more of the preprocessor circuitries 102A-102C send the predicted sign of the partial convolution value to the control 106. At this point the process flow of FIG. 3 is finished.

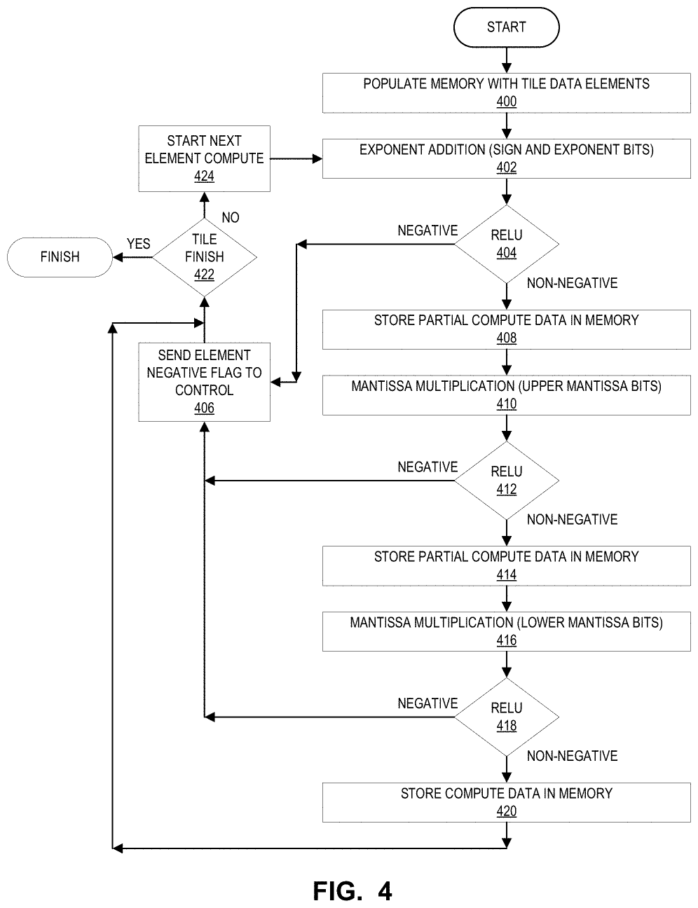

FIG. 4 is another flowchart representative of example machine readable instructions that may be executed by example processor circuitry to implement a prediction of the sign for the ReLU activation function with partial data. The process flow is performed by the processing element array circuitries 100A-100C (including the preprocessor circuitries 102A-102C and the remainder processing circuitries 104A-104C), the control 106 (i.e., the activation function control and decode circuitry), the L1 memory circuitry 108, the higher level memory circuitry 110, the IBC 112, the KWBC 114, the DDC 116 as illustrated in FIG. 1.

In the illustrated example of FIG. 4, the process begins at block 400 where input data is fed into the CNN to be processed and the activation function control and decode circuitry (control 106) populates a memory with tile data elements. In some examples, the input data includes a series of tiles that make up an image. In some examples, at least a tile's worth of data is populated in the memory at a given time. In some examples, the control reads input data from a higher level memory 110, rearranges the input data, and populates the input data into an L1 memory 108 in separate groups. FIG. 2 illustrates an example of how the control may populate the L1 memory 108 with the input data from a tile. In some examples, the memory is a designated hardware buffer (e.g., data distribution circuitry 116). In some examples, the memory is a range of memory locations in L1 memory 108. In other examples, the memory is any form of memory capable of storing input data and accessible by the other circuitry in the system shown in FIG. 1. In some examples, once the memory is populated with the tile data elements in block 400, the control 106 triggers one or more of the processing element array circuitries (100A-100C), and, more specifically, one or more of the preprocessor circuitries 102A-102C, to begin processing the elements in the tile, beginning with the first element.

The example process continues at block 402 when one or more of the preprocessor circuitries 102A-102C perform an exponent addition with the sign and exponent bits from the input data populated in the memory and a weight data.

The example process continues at block 404 when one or more of the preprocessor circuitries 102A-102C checks the result of the exponent addition in block 402 for a predicted negative value of the partial convolution result for a ReLU activation function.

If the predicted result of the exponent addition is negative, then the example process continues at block 406 when one or more of the preprocessor circuitries 102A-102C sends the element negative flag to the control 106. The element negative flag received by the control 106 indicates that no more processing of the element will be done because the input data value will be negative, thus the ReLU function discards the data.

If the predicted result of the exponent addition is non-negative, then the example process continues at block 408 when one or more of the preprocessor circuitries 102A-102C stores the partial compute data (e.g., a partial convolution value) into the memory (i.e., in response to the non-negative value). In some examples, the partially computed data is only stored into the memory when the predicted result determined in block 404 is a non-negative value. In other examples, the partially computed data is stored into the memory at a location in the process flow of the flowchart immediately above block 404. In these examples, the partially computed data from the exponent addition block 402 is stored into the memory regardless of the predicted sign.

The example process continues at block 410 when one or more of the preprocessor circuitries 102A-102C perform a mantissa multiplication with one or more of the upper mantissa bits (e.g., one or more of the most significant mantissa bits) of the input data populated in the memory and the same relevant bits for the weight data.

The example process continues at block 412 when one or more of the preprocessor circuitries 102A-102C checks the result of the upper mantissa multiplication for a predicted negative value of the partial convolution result for a ReLU activation function. In some examples, the preprocessor circuitries 102A-102C that check for a predicted negative value utilize the exponent addition result value(s) (stored in memory as partial compute data in block 408) with the upper mantissa multiplication result value(s) from block 410 to determine the new combined value (i.e., the partial convolution value of the input and weight sign bits, exponent bits, and upper mantissa bits).

If the predicted result of the upper mantissa multiplication is negative, then the example process continues at block 406 when one or more of the preprocessor circuitries 102A-102C sends the element negative flag to the control 106.

If the predicted result of the upper mantissa multiplication is non-negative, then the example process continues at block 414 when one or more of the preprocessor circuitries 102A-102C stores the partial compute data (i.e., the partial convolution value of the input and weight sign bits, exponent bits, and upper mantissa bits) into the memory.

The example process continues at block 416 when one or more of the remainder circuitries 104A-104C perform a mantissa multiplication with one or more of the lower mantissa bits (e.g., the remaining mantissa bits not utilized in the upper mantissa calculation from block 410) of the input data populated in the memory and the same relevant bits for the weight data. In some examples, the mantissa multiplication is performed in response to the control 106 causing one or more of the remainder circuitries 104A-104C to perform. In some examples, the control 106 triggers one or more of the remainder circuitries 104A-104C to calculate the mantissa for the remaining bits not utilized in the upper mantissa calculation (e.g., a remaining subset of bits not used to calculate the upper mantissa partial convolution result), where the control initiates the trigger in response to receiving a non-negative predicted result from one or more of the preprocessor circuitries 102A-102C.

The example process continues at block 418 when one or more of the preprocessor circuitries 102A-102C checks the result of the lower mantissa multiplication for a negative value of the whole convolution result for a ReLU activation function. In some examples, the preprocessor circuitries 102A-102C that check for the negative value utilize the exponent addition result value(s) (stored in memory as partial compute data in block 408) and the upper mantissa multiplication result value(s) (stored in memory as partial compute data in block 414 with the lower mantissa multiplication result value(s) from block 416 to determine the new combined value (i.e., the full convolution value of the input and weight sign bits, exponent bits, upper mantissa bits, and lower mantissa bits). At this point, there is no longer a predictive nature of the value of the sign because all 32 bits of the original FP32 format data are being utilized in the calculation. Therefore, the sign of the actual convolution result can be determined.

If the result of the lower mantissa multiplication is negative, then the example process continues at block 406 when one or more of the preprocessor circuitries 102A-102C sends the element negative flag to the control 106.

If the result of the lower mantissa multiplication is non-negative, then the example process continues at block 420 when one or more of the preprocessor circuitries 102A-102C store the full compute data (i.e., the full convolution value of the input and weight sign bits, exponent bits, upper mantissa bits, and lower mantissa bits) into the memory.

Returning to block 406 in the example process, once the element negative flag is sent to the control 106, then the example process continues at block 422 when the control 106 checks whether all elements have been processed in the input data tile. If all elements in the tile have been processed, then the example process is finished.

If there are still additional elements to be processed in the input data tile, then the control 106 triggers one or more of the processing element array circuitries (100A-100C), and, more specifically, one or more of the preprocessor circuitries 102A-102C, to begin processing next element(s) in the input data tile and the process repeats.

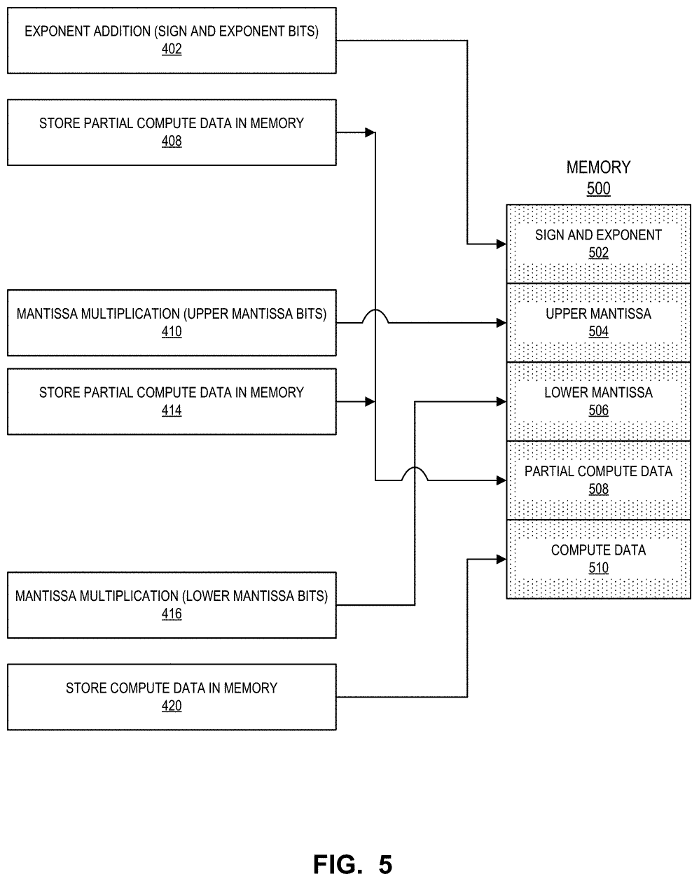

FIG. 5 illustrates an example of the layout of a memory storing the data described in the discussion related to the flowchart of FIG. 4. The flowchart illustrates memory locations where certain results are stored after specific blocks have been performed in FIG. 4.

The example preprocessor circuitries 102A-102C perform the exponent addition at block 402 in FIG. 4 and the result is stored in a memory 500 in a sign and exponent results location 502. In some examples, the memory 500 space shown may be a virtual set of contiguous addresses located in one or more memory circuitries in the system in FIG. 1. In other examples, the memory 500 shown may be physical memory, such as L1 memory 108. In yet other embodiments, the memory 500 shown may be any type of physical memory, storage, or buffer capable of storing such data for components in the system of FIG. 1.

In some examples, when performing block 408 of the flowchart in FIG. 4, the preprocessor circuitries 102A-102C store the partial compute data (determined from block 402 in FIG. 4) in a partial compute data location 508 in the memory 500. In block 408, the partial compute data stored consists of the partial convolution of the input and weight data convolution of the sign bits and the exponent bits. In some examples, the partial compute data 508 memory storage location can be written to by the control 106 and/or one or more of the preprocessor circuitries 102A-102C to store the partial convolution value calculated in exponent addition block 402. In some embodiments, the result of that calculation can be copied from the sign and exponent location 502 of memory 500.

The example preprocessor circuitries 102A-102C perform the upper mantissa multiplication at block 410 in FIG. 4 and the result is stored in the memory 500 in an upper mantissa results location 504. In some examples, when performing the mantissa multiplication, the previous partial compute data results that had been stored in the partial compute data location 508 are read and utilized in furtherance of computing additional bits of the full FP32 operand.

In some examples, when performing block 410 of the flowchart in FIG. 4, the preprocessor circuitries 102A-102C store the partial compute data (determined from block 410 in FIG. 4) in the partial compute data location 508 in the memory 500. In block 414, the partial compute data stored consists of the partial convolution of the input and weight data convolution of the sign bits, the exponent bits, and the upper mantissa bits. In some embodiments, the result of that calculation can be copied from a combination of the sign and exponent results location 502 and the upper mantissa results location 504 of memory 500.

The example preprocessor circuitries 102A-102C perform the lower mantissa multiplication at block 416 in FIG. 4 and the result is stored in the memory 500 in a lower mantissa results location 506. In some examples, when performing the mantissa multiplication, the previous partial compute data results that had been stored in the partial compute data location 508 are read and utilized in furtherance of computing the remaining additional bits of the full FP32 operand.

In some examples, when performing block 416 of the flowchart in FIG. 4, the preprocessor circuitries 102A-102C store the full compute data (determined from block 416 in FIG. 4) in the compute data location 510 in the memory 500. In block 420, the partial compute data stored consists of the full convolution of the input and weight data convolution of the sign bits, the exponent bits, the upper mantissa bits, and the lower mantissa bits. In some embodiments, the result of that calculation can be copied from a combination of the sign and exponent results location 502, the upper mantissa results location 504, and the lower mantissa results location 506 of memory 500.

FIG. 6A illustrates an example number format of an FP32 data type used for predicting a ReLU activation function result in a CNN. In some examples, with a FP32 data type, a reduced number of mantissa bits are used to calculate a convolution value from an input value and a weight value. The example format in FIG. 6A includes a 1-bit sign value 600 (bit [31]), an 8-bit exponent value 602 (bits [31:23]), an upper mantissa value 604 (N bits), and a lower mantissa value 606 (22-N bits). For example, if the upper mantissa value is a 4-bit value (bits [22:19]), then the lower mantissa value is a 19 bit value (bits [18:0]). In other examples, different permutations of the bit-size of the upper and lower mantissa values may be utilized.

The mantissa bits that are used to predict a ReLU activation function result begin with the most significant bits of the mantissa value (i.e., the upper bits; the upper mantissa value). The mantissa bits that are not used for partial convolution value prediction include a series of consecutive mantissa bits from the least significant bit (bit [0]) up to the bit immediately below the least significant bit of the upper mantissa value. In some examples, the prediction of the ReLU activation function result utilizes the sign value 600, the exponent value 602, and the upper mantissa value 604. Removing the lower mantissa value from a calculation reduces the precision of the result.

Consider examining a 32-bit value. In an example first examination of the value, all 32 bits are visible/available, therefore predicting the value is not necessary because the entire value is known (i.e., an ideal calculation using all mantissa bits). In an example second examination of the value, the most significant 13 bits of the value are visible (i.e., the least significant 19 bits are not visible leading to a reduced precision of the value). The reduced precision of the value may include an error of up to the maximum size of the not visible least significant bits.

Returning to calculating a partial sum of a convolution, the error corresponds to a region of interest where there may be a discrepancy between a calculated ideal partial sum value of the convolution (using all mantissa bits in the calculation) and a calculated partial sum value of the convolution using a reduced number of mantissa bits. In some examples, the partial sum that utilizes the reduced number of mantissa bits may have a different sign than the ideal partial sum. In some examples, the absolute value of the actual mantissa will be greater than or equal to the absolute value of the predicted mantissa.

FIG. 6B illustrates an example region of interest where a reduced precision of an FP32 input value and weight value used to calculate a partial convolution value may cause a prediction error of a ReLU activation function result. In some examples, the result loses precision and, in turn, increases a range of possible error in the prediction due to the calculation not using a subset of the mantissa bits (e.g., one or more lower/least significant mantissa bits). In the example described above regarding FIG. 6A, the lower 19 bits of the mantissa of the input value and the weight value are not utilized in the partial convolution value calculation.

As shown in FIG. 6B, an example region of interest 608 is shown on a number line 610 of the example calculated partial convolution value where there is likely a delta between a predicted value and the true value. The delta may result in the sign of the predicted value being different than the sign of the true value.

In some examples, performing convolution using a reduced number of mantissa bits can produce erroneous ReLU prediction because of missed inclusion of remaining mantissa bits for positive elements only. Negative elements further aid ReLU fail and hence does not contribute to the final error.

In some examples, it can be determined mathematically that a subset of the entire input data of FP32 data type can be utilized to sufficiently predict negative values for convolutional matrix multiplications involving input data and weights. Thus, not all 32-bits of FP32 data are needed to accurately predict negative results. Below is a series of mathematical proofs that show some examples of the region of interest, the max possible error in prediction, and conditions to be checked to qualify the predictions. Following those requirements, in some examples, a significant reduction in bits utilized to accurately predict the sign of a partial convolution value is achievable.

For the following description, let:
X_{S}=Partial sum of convolution operation using reduced mantissa bits. For example, in a 32 channel CONV operation X_{S} can represent first 16 channel computation.
X_{Reduced}=Partial sum of convolution with reduced mantissa bits.
X_{S}^{Reduced}=Final sum of the CONV operation considering reduced mantissa bits.
X_{Ideal}=Partial sum of convolution considering all mantissa bits.
X_{S}^{Ideal}=Final sum of the CONV operation considering all mantissa bits.

This can also be represented as,

X_{S}^{Ideal}=X_{S}+X_{Ideal} (Equation 1)

X_{S}^{Reduced}=X_{S}+X_{Reduced} (Equation 2)

In some examples, reducing the number of mantissa bits in a floating-point number results in the number having a lower absolute magnitude. However, the sign remains unaffected as the sign bit is unchanged. Hence, if

X_{Ideal}<0

⇒X_{Reduced}>X_{Ideal}

⇒X_{S}+X_{Reduced}>X_{S}+X_{Ideal}

In some examples, Equations 1 and 2 show that)

X_{S}^{Reduced}>X_{S}^{Ideal} (Equation 3)

In some examples, Equation 3 shows that if X_{S}^{Reduced}<0, then X_{S}^{Ideal}<0. An error due to the addition of a negative value cannot alter the sign of the sum from positive to negative. Therefore

if X_{Ideal}>0

then X_{Reduced}<X_{Ideal}

then X_{S}+X_{Reduced}<X_{S}+X_{Ideal}

Again, in some examples, Equations 1 and 2 show that

X_{S}^{Reduced}<X_{S}^{Ideal} (Equation 4)

In some examples, for Equation 4, X_{S}^{Reduced}<0 does not guarantee X_{S}^{Ideal}<0. Thus, errors due to the addition of positive values will contribute towards a possible sign change from positive to negative. These errors can be utilized to determine a threshold value to compare against to conclude that the convolution sum is negative when calculating a partial convolution value using a reduced amount of mantissa bits.

In some examples, if a positive term in the convolution sum is given by C_{Mut}=2^{E}^{_{Mul}}×M_{Mul}, where E_{Mul} and M_{Mul} are the unbiased exponent and mantissa value of the term, the maximum error that is possible when the number of mantissa bits is reduced by n is given by C_{Errmax}=2^{E}^{_{Mul}}⁻ⁿ⁺¹×M_{Mul}.

In some examples, for any floating-point number given by

N=(−1)^{S}×2^{E}×M

where S, E, M represent the sign, unbiased exponent and mantissa value, the maximum possible error when only n mantissa bits are included is given by

E_{Max}=−2^{(E-n)}×(−1)^{S} (Equation 5)

Consider an activation input (I) and weight (W) of a convolution layer. They are represented as

I=(−1)^{S}^{_{I}}×2^{E}^{_{I}}×M_{I} (Equation 6)

W=(−1)^{S}^{_{W}}×2^{E}^{_{W}}×M_{W} (Equation 7)

From Equation 5, in some examples, the most erroneous values that could result from reducing the number of mantissa bits to n in I (from Equation 6) and W (from Equation 7) is given by

I_{Reduced}=(−1)^{S}^{_{I}}×2^{E}^{_{I}}×M_{I}−2^{(E}^{_{I}}⁻ⁿ⁾×(−1)^{S}^{_{I}} (Equation 8)

W_{Reduced}=(−1)^{S}^{_{W}}×2^{E}^{_{W}}×M_{W}−2^{(E}^{_{W}}⁻ⁿ⁾×(−1)^{S}^{_{W}} (Equation 9)

In some examples, the convolution term, when I (from Equation 6) and W (from Equation 7) are multiplied, is given by

C_{Ideal}=(−1)^{S}^{_{I}}^{+W}^{_{W}}×2^{E}^{_{I}}^{+E}^{_{W}}×(M_{I}×M_{W}) (Equation 10)

In some examples, with reduced mantissa in the convolution step, (Equation 8) and (Equation 9) gives

C_{Reduced}=I_{Reduced}×W_{Reduced}=(−1)^{S}^{_{I}}^{+W}^{_{W}}×2^{E}^{_{I}}^{+E}^{_{W}}×(M_{I}×M_{W})−(−1)^{S}^{_{I}}^{+S}^{_{W}}×2^{E}^{_{I}}^{+E}^{_{W}}⁻ⁿ×(M_{I}+M_{W})+2^{E}^{_{I}}^{+E}^{_{W}}⁻²n

Thus,

C_{Reduced}=2^{E}^{_{I}}^{+E}^{_{W}}×(M_{I}×M_{W})−2⁻ⁿ×(M_{I}+M_{W}−2⁻ⁿ) (Equation 11)

In some examples, the error in convolution terms due to reduced mantissa can be obtained from (Equation 10) and (Equation 11)

C_{Error}=C_{Ideal}−C_{Reduced}=2^{E}^{_{I}}^{+E}^{_{W}}⁻ⁿ×(M_{I}+M_{W}+2⁻ⁿ)

In some examples, because 2′ is always positive,

C_{Error}≤2^{E}^{_{I}}^{+E}^{_{W}}⁻ⁿ×(M_{I}+M_{W}) (Equation 12)

Since M_{I} and M_{W} represent the mantissa values,

1≤M_{I},M_{W}<2

⇒M_{I}+M_{W}≤2×M_{I}×M_{W}

Therefore, (Equation 12) can be rewritten as

C_{Error}≤2^{E}^{_{I}}^{+E}^{_{W}}⁻ⁿ×(2×M_{I}×M_{w})=2^{E}^{_{I}}^{+E}^{_{W}}ⁿ⁺¹×(M_{I}+M_{W})

In some examples, (Equation 10) provides

C_{Error}≤2×C_{Ideal} (Equation 13)

In some examples, Theorem 1 illustrates that only positive terms will contribute to errors that can contribute to incorrectly identifying a negative value. Hence, S_{I}+S_{W}=0 (Either both I and W are positive or both are negative).

In (Equation 10), C_{Ideal} can be rewritten as

C_{Ideal}=2^{E}^{_{Mul}}×M_{Mul} (Equation 14)

where E_{Mul}=E_{I}+E_{W} and M_{Mul}=M_{I}×M_{W}.

Thus, in some examples, the maximum error in a positive term in the convolution sum is

C_{ErrMax}=2^{E}^{_{Mul}}⁻ⁿ⁺¹×M_{Mul} (Equation 15)

In some examples, if the convolution sum before the ReLU activation layer is given by C_{Tot}=(−1)^{S}^{_{Tot}}×2^{E}^{_{Tot}}×M_{Tot}, and the sum of positive terms in the summation (including the bias value) is given by C_{Pos}=2^{E}^{_{Pos}}×M_{Pos}, then the value of C_{Tot} can be concluded to be negative if S_{Tot}=1 and E_{Tot}>E_{Pos}−n, where n is the number of mantissa bits used in the computation.

In some examples, the sum of all product terms in the convolution is given by

$${C}_{Tot} = {\sum }_{i} {( - 1 )}^{{S}_{i}} \times {2}^{{E}_{i}} \times {M}_{i} = {( - 1 )}^{{S}_{Tot}} \times {2}^{{E}_{Tot}} \times {M}_{Tot} \qquad ( Equation 16 )$$

In some examples, from (Equation 15), the maximum error due to positive terms in the convolution is given by C_{ErrMax}ⁱ=2^{E}^{ᵢ}⁻ⁿ⁺¹×Mᵢ. Thus, in some examples, the following equation represents when errors are accumulated for all positive terms (including bias),

$${C}_{ErrTot} = {\sum }_{i \text{:} {S}_{i} = 0} {C}_{ErrMax}^{i} = {\sum }_{i \text{:} {S}_{i} = 0} {2}^{{E}_{i} - n + 1} \times {M}_{i} \qquad ( Equation 17 )$$

In some examples, unlike other terms in the convolution sum, the bias does not involve multiplication of reduced mantissa numbers. Thus, the maximum error for bias values will be lower. However, in some examples, the same error is considered (as an upper bound) to simplify calculations.

In some examples, the sum of positive terms (including bias) in the convolution sum is represented as

$${C}_{Pos} = {\sum }_{i \text{:} {S}_{i} = 0} {2}^{{E}_{i}} \times {M}_{i} = {2}^{{E}_{Pos}} \times {M}_{Pos} \qquad ( Equation 18 )$$

In some examples, using (Equation 18), the total error in (Equation 17) can be rewritten as,

C_{ErrTot}=2⁻ⁿ⁺¹×C_{Pos} (Equation 19)

In some examples, to conclude that a convolution sum is zero/negative, the following two conditions should hold:

|C_{Tot}|≥|C_{Pos}| (Equation 20)

S_{Tot}=1 (Equation 21)

In some examples, (Equation 20) can be expanded using (Equation 16) and (Equation 18) to give

2^{E}^{_{Tot}}×M_{Tot}≥2^{E}^{_{Pos}}⁻ⁿ⁺¹×M_{Pos} (Equation 22)

In some examples, note that if E_{Tot}=E_{Pos}−n+1, then the condition M_{Tot}≥M_{Pos} must hold (As the total convolution sum (C_{Tot}) must be greater than or equal to the sum of positive convolution terms and bias (C_{Pos}))

Thus, in some examples, (Equation 22) now becomes

E_{Tot}≥E_{Pos}−n+1 (Equation 23)

⇒E_{Tot}>E_{Pos}−n (Equation 24)

Therefore, from (Equation 21) and (Equation 24), in some examples, it holds that a convolution sum computed using reduced-mantissa bits is negative (and the ReLU output is zero) if S_{Tot}=1, M_{Tot}≥M_{Pos} and E_{Tot}>E_{Pos}−n.

FIG. 7 is a block diagram of an example processor platform 700 structured to execute and/or instantiate the machine readable instructions and/or operations of FIGS. 3 through 5 to implement the apparatus of FIG. 1. The processor platform 700 can be, for example, a server, a personal computer, a workstation, a self-learning machine (e.g., a neural network), a mobile device (e.g., a cell phone, a smart phone, a tablet such as an iPad), an Internet appliance, a DVD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 700 of the illustrated example includes processor circuitry 712. The processor circuitry 712 of the illustrated example is hardware. For example, the processor circuitry 712 can be implemented by one or more integrated circuits, logic circuits, FPGAs microprocessors, CPUs, GPUs, DSPs, and/or microcontrollers from any desired family or manufacturer. The processor circuitry 712 may be implemented by one or more semiconductor based (e.g., silicon based) devices. In this example, the processor circuitry 712 implements the example processing element array circuitries 100A-100C (including the example preprocessor circuitries 102A-102C and the example remainder processing circuitries 104A-104C), the example control 106 circuitry, the example L1 memory circuitry 108, the example higher level memory circuitry 110, the example IBC 112, the example KWBC 114, and/or the example DDC 116. In some examples, tile processing logic 118 and the circuitry within (shown in greater detail in FIG. 1) is located at least partially in processor circuitry 712.

The processor circuitry 712 of the illustrated example includes a local memory 713 (e.g., a cache, registers, etc.). The processor circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717.

The processor platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 722 are connected to the interface circuitry 720. The input device(s) 722 permit(s) a user to enter data and/or commands into the processor circuitry 712. The input device(s) 722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 724 are also connected to the interface circuitry 720 of the illustrated example. The output devices 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 700 of the illustrated example also includes one or more mass storage devices 728 to store software and/or data. Examples of such mass storage devices 728 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 732, which may be implemented by the machine readable instructions of FIGS. 3 through 5, may be stored in the mass storage device 728, in the volatile memory 714, in the non-volatile memory 716, and/or on a removable non-transitory computer readable storage medium such as a CD or DVD.

FIG. 8 is a block diagram of an example implementation of the processor circuitry 712 of FIG. 7. In this example, the processor circuitry 712 of FIG. 7 is implemented by a microprocessor 800. For example, the microprocessor 800 may implement multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowchart of FIGS. 3 through 5.

The cores 802 may communicate by an example bus 804. In some examples, the bus 804 may implement a communication bus to effectuate communication associated with one(s) of the cores 802. For example, the bus 804 may implement at least one of an Inter-Integrated Circuit (I2C) bus, a Serial Peripheral Interface (SPI) bus, a PCI bus, or a PCIe bus. Additionally or alternatively, the bus 804 may implement any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2_cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the L1 cache 820, and an example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating point operations. In yet other examples, the AL circuitry 816 may include first AL circuitry that performs integer based operations and second AL circuitry that performs floating point operations. In some examples, the AL circuitry 816 may be referred to as an Arithmetic Logic Unit (ALU). The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure including distributed throughout the core 802 to shorten access time. The bus 820 may implement at least one of an I2C bus, a SPI bus, a PCI bus, or a PCIe bus

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general puspose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

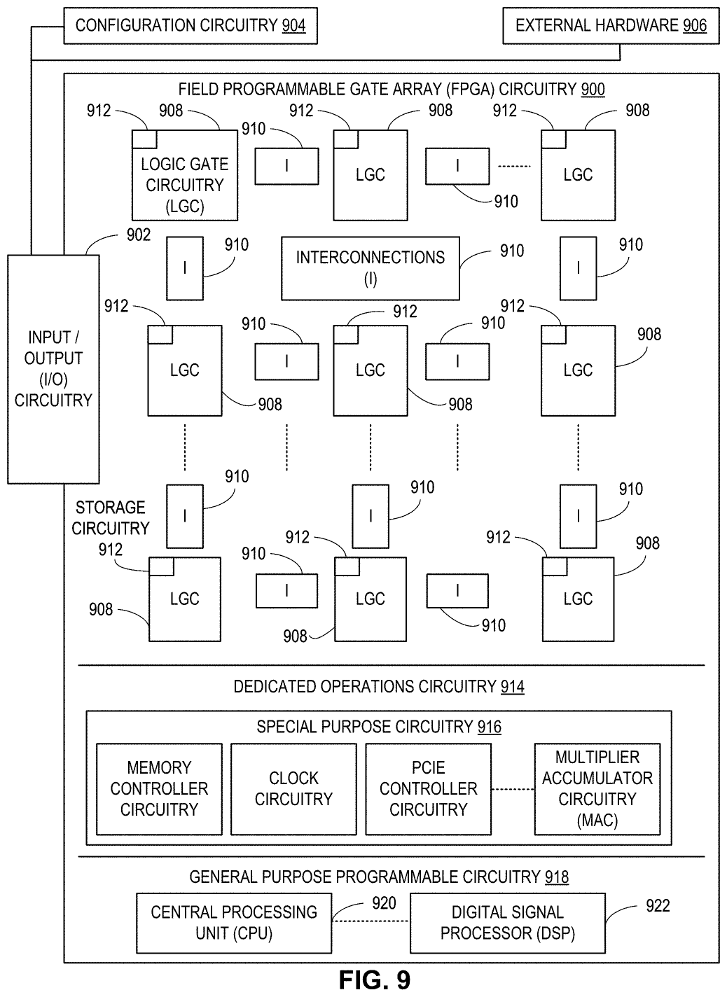

FIG. 9 is a block diagram of another example implementation of the processor circuitry 712 of FIG. 7. In this example, the processor circuitry 800 is implemented by FPGA circuitry 900. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the machine readable instructions in hardware and, thus, can often execute the operations faster than they could be performed by a general purpose microprocessor executing the corresponding software.

More specifically, in contrast to the microprocessor 800 of FIG. 8 described above (which is a general purpose device that may be programmed to execute some or all of the machine readable instructions represented by the flowcharts of FIG. 3 through 5 but whose interconnections and logic circuitry are fixed once fabricated), the FPGA circuitry 900 of the example of FIG. 9 includes interconnections and logic circuitry that may be configured and/or interconnected in different ways after fabrication to instantiate, for example, some or all of the machine readable instructions represented by the flowchart of FIG. 3. In particular, the FPGA 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the software represented by the flowchart of FIG. 3. As such, the FPGA circuitry 900 may be structured to effectively instantiate some or all of the machine readable instructions of the flowchart of FIG. 3 as dedicated logic circuits to perform the operations corresponding to those software instructions in a dedicated manner analogous to an ASIC. Therefore, the FPGA circuitry 900 may perform the operations corresponding to the some or all of the machine readable instructions of FIG. 3 faster than the general purpose microprocessor can execute the same.

In the example of FIG. 9, the FPGA circuitry 900 is structured to be programmed (and/or reprogrammed one or more times) by an end user by a hardware description language (HDL) such as Verilog. The FPGA circuitry 900 of FIG. 9, includes example input/output (I/O) circuitry 902 to obtain and/or output data to/from example configuration circuitry 904 and/or external hardware (e.g., external hardware circuitry) 906. For example, the configuration circuitry 904 may implement interface circuitry that may obtain machine readable instructions to configure the FPGA circuitry 900, or portion(s) thereof. In some such examples, the configuration circuitry 904 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 906 may implement the microprocessor 800 of FIG. 8. The FPGA circuitry 900 also includes an array of example logic gate circuitry 908, a plurality of example configurable interconnections 910, and example storage circuitry 912. The logic gate circuitry 908 and interconnections 910 are configurable to instantiate one or more operations that may correspond to at least some of the machine readable instructions of FIG. 3 and/or other desired operations. The logic gate circuitry 908 shown in FIG. 9 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations. The logic gate circuitry 908 may include other electrical structures such as look-up tables (LUTs), registers (e.g., flip-flops or latches), multiplexers, etc.

The interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example Dedicated Operations Circuitry 914. In this example, the Dedicated Operations Circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the processor circuitry 712 of FIG. 7, many other approaches are contemplated. For example, as mentioned above, modern FPGA circuitry may include an on-board CPU, such as one or more of the example CPU 920 of FIG. 9. Therefore, the processor circuitry 712 of FIG. 7 may additionally be implemented by combining the example microprocessor 800 of FIG. 8 and the example FPGA circuitry 900 of FIG. 9. In some such hybrid examples, a first portion of the machine readable instructions represented by the flowchart of FIG. 3 may be executed by one or more of the cores 802 of FIG. 8 and a second portion of the machine readable instructions represented by the flowchart of FIG. 3 may be executed by the FPGA circuitry 900 of FIG. 9.

In some examples, the processor circuitry 712 of FIG. 7 may be in one or more packages. For example, the processor circuitry 800 of FIG. 8 and/or the FPGA circuitry 900 of FIG. 9 may be in one or more packages. In some examples, an XPU may be implemented by the processor circuitry 712 of FIG. 7, which may be in one or more packages. For example, the XPU may include a CPU in one package, a DSP in another package, a GPU in yet another package, and an FPGA in still yet another package.

From the foregoing, it will be appreciated that example apparatus, methods, and articles of manufacture have been disclosed that predict results of activation functions in convolutional neural networks.

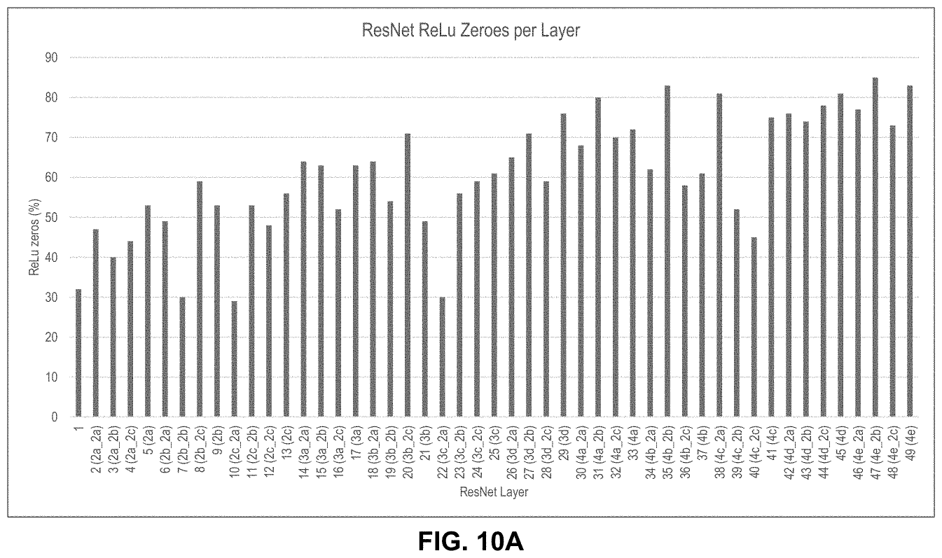

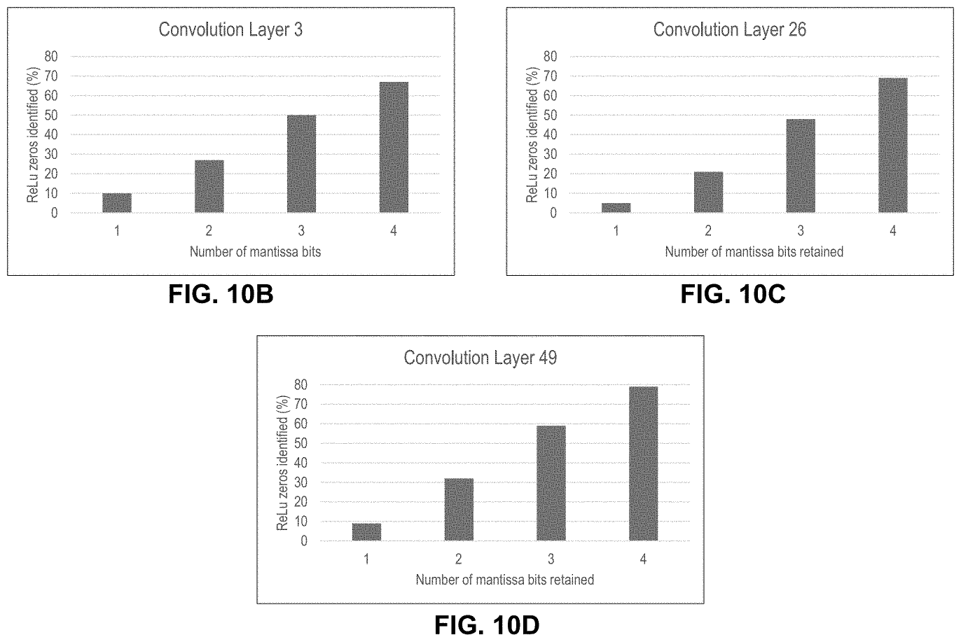

To test the proficiency of the system illustrated in FIG. 1 to predict the sign of partial convolution calculations, a series of tests with standard CNN models were observed in operation. FIG. 10A illustrates an example distribution graph of ReLU zero results across all layers (i.e., nodes) of the ResNet-50 model. When a layer in the ResNet model outputs a zero, the convolution value at that layer was not utilized due to a negative result (thus, clamping the output to zero).

The dataset used was the ImageNet inference dataset from ILSVRC2012, which is 50,000 images from 1,000 classes. As can be seen, a significant number of results were clamped to zero. Specifically, 61.14% of the outputs of the ReLU layers were zero for the ResNet-50 architecture with pretrained ImageNet weights. Additionally, as can be observed in FIG. 10A, deeper layers into the model are more sparse with actual output with certain layers returning 80+% zeros across the dataset. The resulting outputs per layer have an element value distribution that is mostly confined within −4 to +4 due to batch normalization and 50% of the elements are confined within an output range of −1 to +1.

FIG. 10B-10D illustrate samples of the accuracy of the predicted negative result on a sample of three different convolution layers in the ResNet-50 model across a scale of mantissa bits used in the prediction. The implemented prediction model accuracy shows that as upper mantissa bits utilized in the partial convolution calculation (along with the sign bit and the exponent bits) are increased from 0 to 3, the negative values that were correctly predicted across the dataset increase from ˜10% at 0 upper mantissa bits up to ˜70% at 3 upper mantissa bits. Specifically, this shows the percentage of negative values matching between the predicted value and the full precision using all 32-bits. Thus, the 3 most significant (upper) mantissa bits, combined with the sign bit and exponent bits of an FP32 input data value will allow the model to predict almost 7 out of every 10 negative values. Thus, 20 of the 32 bits do not require circuitry calculations, which lowers overall processing requirements. The result also means that about 3 out of every 10 values the model predicts as non-negative eventually turns negative once the full mantissa is eventually calculated to verify a negative or non-negative value.

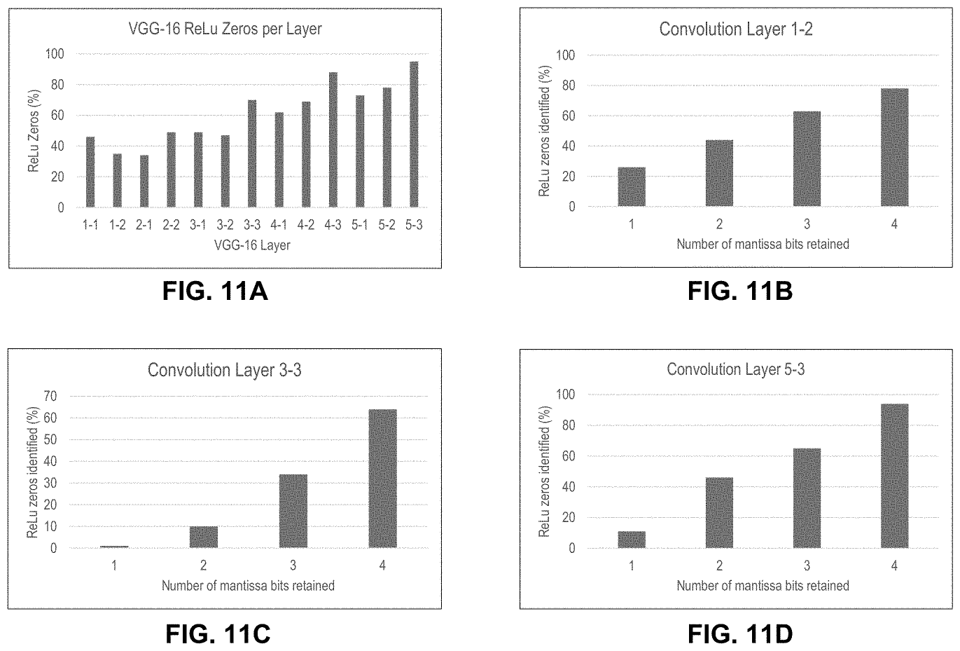

FIG. 11A illustrates an example distribution graph of ReLU zero results across all layers (i.e., nodes) of the VGG-16 model when run through the same ImageNet dataset. Similar to the ResNet-50 model above, if a given VGG-16 layer returns a 0 from a ReLU activation function, that means the convolution calculation returns a negative value, which clamps to zero.

FIG. 11B-11D illustrate samples of the accuracy of the predicted negative result on a sample of three different convolution layers in the VGG-16 model across a scale of mantissa bits used in the prediction. As can be seen, the predicted negative accuracy ranges from between 60-80% when 3 mantissa bits are used in the upper mantissa calculation. With the example preprocessor circuitries 102A-102C, 20 bit multiplication was eliminated in VGG-16 for about 48% of cases across all types of deep neural networks/convolutional neural networks. For cases where the predicted sign is positive, the computed result of the example preprocessor circuitries 102A-102C can be saved in the DDC 116 and the result of the remainder processing circuitry 104A-104C that performs multiplication of the remaining bits of mantissa are then combined in the DDC 116.

From the foregoing, it will be appreciated that example systems, methods, apparatus, and articles of manufacture have been disclosed that predict the sign of an activation function in a neural network. The disclosed systems, methods, apparatus, and articles of manufacture improve the efficiency of using a computing device by predicting the sign of an activation function used for classification in a neural network prior to calculating all bits of the mantissa. Predicting the sign of an activation function accurately with less than full mantissa calculations reduces the amount of compute cycles required to run a neural network. The disclosed systems, methods, apparatus, and articles of manufacture are accordingly directed to one or more improvement(s) in the operation of a machine such as a computer or other electronic and/or mechanical device.

Although certain example apparatus and articles of manufacture have been disclosed herein, the scope of coverage of this patent is not limited thereto. On the contrary, this patent covers all systems, methods, apparatus, and articles of manufacture fairly falling within the scope of the claims of this patent. Further examples and combinations thereof include the following:

[EXAMPLE PARAGRAPHS MAPPING TO ALL CLAIMS WILL BE INSERTED WHEN A VERSION OF THE CLAIMS HAVE BEEN APPROVED]

The following claims are hereby incorporated into this Detailed Description by this reference, with each claim standing on its own.

What is claimed is:

1. An apparatus, comprising:
processor circuitry including one or more of:
at least one of a central processing unit, a graphic processing unit or a digital signal processor, the at least one of the central processing unit, the graphic processing unit or the digital signal processor having control circuitry to control data movement within the processor circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or
an Application Specific Integrate Circuitry (ASIC) including logic gate circuitry to perform one or more third operations;
the processor circuitry to perform at least one of the one or more first operations, the one or more second operations or the one or more third operations to instantiate:
an activation function control and decode circuitry to
populate an input buffer circuitry with an input data element bit subset of less than a threshold number of bits of an input data element retrieved from a memory circuitry; and
populate a kernel weight buffer circuitry with a weight data element bit subset of less than the threshold number of bits of a weight data element retrieved from the memory circuitry; and
a preprocessor circuitry to
calculate a partial convolution value of at least a portion of the input data element bit subset and the weight data element bit subset to determine a predicted sign of the partial convolution value; and
send the predicted sign of the partial convolution value to the activation function control and decode circuitry.

2. The apparatus of claim 1, wherein the processor circuitry is to further perform at least one of the one or more first operations, the one or more second operations or the one or more third operations to instantiate:
the preprocessor circuitry to store the partial convolution value in a data distribution circuitry in response to the predicted sign of the partial convolution value being non-negative;
the activation function control and decode circuitry to cause a remainder processing circuitry to calculate a full convolution value of the input data element and the weight data element in response to the predicted sign of the partial convolution value being non-negative; and
the remainder processing circuitry to calculate the full convolution value from the partial convolution value and a remaining subset of bits of the input data and weight data not used to determine the predicted sign of the partial convolution value, the partial convolution value retrieved from the data distribution circuitry.

3. The apparatus of claim 2, wherein the partial convolution value is a first partial convolution value and the portion of the input data element bit subset and the weight data element bit subset is a first portion of the input data element bit subset and the weight data element bit subset, and wherein the processor circuitry is to further perform at least one of the one or more first operations, the one or more second operations or the one or more third operations to instantiate:
the preprocessor circuitry to calculate at least a second partial convolution value of at least a second portion of the input data element bit subset and the weight data element bit subset.

4. The apparatus of claim 2, wherein the input data element is a first input data element, and wherein the processor circuitry is to further perform at least one of the one or more first operations, the one or more second operations or the one or more third operations to instantiate:
the input buffer circuitry to include a plurality of banks to store a plurality of input data elements comprising an input data tile, the input data tile including the first input data element.

5. The apparatus of claim 4, wherein the preprocessor circuitry is a first preprocessor circuitry and the partial convolution value is a first partial convolution value, and wherein the processor circuitry is to further perform at least one of the one or more first operations, the one or more second operations or the one or more third operations to instantiate:
a plurality of preprocessor circuitries including the first preprocessor circuitry, wherein each of the plurality of preprocessor circuitries to calculate at least one of a plurality of partial convolution values, the plurality of partial convolution values calculated from at least a portion of each of the plurality of input data elements in the input data tile.

6. The apparatus of claim 2, wherein the input data is a first input data, and wherein the processor circuitry is to further perform at least one of the one or more first operations, the one or more second operations or the one or more third operations to instantiate:
the preprocessor circuitry to calculate a second partial convolution value of a second input data and the weight data while the remainder processing circuitry calculates the full convolution value of the first input data and the weight data.

7. The apparatus of claim 1 wherein the activation function is a rectified linear unit (ReLu) function.

8. The apparatus of claim 1, wherein the input data and the weight data are a 32-bit floating point data type.

9. The apparatus of claim 8, wherein the processor circuitry is to further perform at least one of the one or more first operations, the one or more second operations or the one or more third operations to instantiate:
the preprocessor circuitry to calculate the partial convolution value using a sign bit and one or more exponent bits of the input data and the weight data.

10. The apparatus of claim 8, wherein the processor circuitry is to further perform at least one of the one or more first operations, the one or more second operations or the one or more third operations to instantiate:
the preprocessor circuitry to calculate the partial convolution value using a sign bit, one or more exponent bits, and one or more upper mantissa bits of the input data and the weight data.

11. The apparatus of claim 8, wherein the processor circuitry is to further perform at least one of the one or more first operations, the one or more second operations or the one or more third operations to instantiate:
the activation function control and decode circuitry to arrange the input data and the weight data in the memory circuitry separately into a sign bit group, an exponent bits group, an upper mantissa bits group, and a lower mantissa bits group.

12. A non-transitory computer-readable storage medium comprising instructions that, when executed, cause one or more processors of a machine to at least:
populate an input buffer circuitry with an input data element bit subset of less than a threshold number of bits bits of the input data element retrieved from a memory circuitry;
populate a kernel weight buffer circuitry with a weight data element bit subset of less than the threshold number of bits bits of the weight data element retrieved from the memory circuitry;
calculate a partial convolution value of at least a portion of the input data element bit subset and the weight data element bit subset to determine a predicted sign of the partial convolution value; and
send the predicted sign of the partial convolution value to an activation function control and decode circuitry.

13. The non-transitory computer-readable storage medium of claim 12, wherein the instructions, when executed, cause the one or more processors of the machine to at least:
store the partial convolution value in a data distribution circuitry in response to the predicted sign of the partial convolution value being non-negative;
calculate a full convolution value of the input data element and the weight data element in response to the predicted sign of the partial convolution value being non-negative; and
calculate the full convolution value from the partial convolution value and a remaining subset of bits of the input data and weight data not used to determine the predicted sign of the partial convolution value, the partial convolution value retrieved from the data distribution circuitry.

14. The non-transitory computer-readable storage medium of claim 13, wherein the partial convolution value is a first partial convolution value and the portion of the input data element bit subset and the weight data element bit subset is a first portion of the input data element bit subset and the weight data element bit subset, wherein the instructions, when executed, cause the one or more processors of the machine to:
calculate at least a second partial convolution value of at least a second portion of the input data element bit subset and the weight data element bit subset.

15. The non-transitory computer-readable storage medium of claim 13, wherein the input data element is a first input data element, and wherein the instructions, when executed, cause the one or more processors of the machine to:
store a plurality of input data elements comprising an input data tile, the input data tile including the first input data element.

16. The non-transitory computer-readable storage medium of claim 15, wherein the partial convolution value is a first partial convolution value, and wherein the instructions, when executed, cause the one or more processors of the machine to:
calculate at least one of a plurality of partial convolution values, the plurality of partial convolution values calculated from at least a portion of each of the plurality of input data elements in the input data tile.

17. The non-transitory computer-readable storage medium of claim 13, wherein the input data is a first input data, and wherein the instructions, when executed, cause the one or more processors of the machine to:
calculate a second partial convolution value of a second input data and the weight data in parallel to calculating the full convolution value of the first input data and the weight data.

18. The non-transitory computer-readable storage medium of claim 12, wherein the activation function is a rectified linear unit activation function, wherein the input data and the weight data are a 32-bit floating point data type.

19. The non-transitory computer-readable storage medium of claim 18, wherein the instructions, when executed, cause the one or more processors of the machine to:
calculate the partial convolution value using a sign bit and one or more exponent bits of the input data and the weight data.

20. The non-transitory computer-readable storage medium of claim 18, wherein the instructions, when executed, cause the one or more processors of the machine to:
calculate the partial convolution value using a sign bit, one or more exponent bits, and one or more upper mantissa bits of the input data and the weight data.

21. The non-transitory computer-readable storage medium of claim 18, wherein the instructions, when executed, cause the one or more processors of the machine to:
arrange the input data and the weight data in the memory circuitry separately into a sign bit group, an exponent bits group, an upper mantissa bits group, and a lower mantissa bits group.

22. An apparatus comprising:
means for populating an input buffer circuitry with an input data element bit subset of less than a threshold number of bits bits of the input data element retrieved from a memory circuitry;
means for populating a kernel weight buffer circuitry with a weight data element bit subset of less than the threshold number of bits bits of the weight data element retrieved from the memory circuitry;
means for calculating a partial convolution value of at least a portion of the input data element bit subset and the weight data element bit subset to determine a predicted sign of the partial convolution value; and
means for sending the predicted sign of the partial convolution value to an activation function control and decode circuitry.

23. The apparatus of claim 22, further comprising:
means for storing the partial convolution value in a data distribution circuitry in response to the predicted sign of the partial convolution value being non-negative;
means for calculating a full convolution value of the input data element and the weight data element in response to the predicted sign of the partial convolution value being non-negative; and
means for calculating the full convolution value from the partial convolution value and a remaining subset of bits of the input data and weight data not used to determine the predicted sign of the partial convolution value, the partial convolution value retrieved from the data distribution circuitry.

25. The apparatus of claim 24, wherein the partial convolution value is a first partial convolution value and the portion of the input data element bit subset and the weight data element bit subset is a first portion of the input data element bit subset and the weight data element bit subset, further comprising:
means for calculating at least a second partial convolution value of at least a second portion of the input data element bit subset and the weight data element bit subset.

25. The non-transitory computer-readable storage medium of claim 24, wherein the input data element is a first input data element, and further comprising:
means for storing a plurality of input data elements comprising an input data tile, the input data tile including the first input data element.
